(19) United States
(12) Patent Application Publication
(10) Pub. No.: US 2013/0118378 A1
(43) Pub. Date: May 16, 2013

(54) SILICA HYDROGEL IMPREGNATED WITH TiO2 AND METHOD OF MAKING SAME

(71) Applicants: Flavio Ernesto Ribeiro, Plainfield, IL (US); Ronaldo dos Santos Flor, Sao Bernardo do Campo-SP (BR)

(72) Inventors: Flavio Ernesto Ribeiro, Plainfield, IL (US); Ronaldo dos Santos Flor, Sao Bernardo do Campo-SP (BR)

(73) Assignee: PQ CORPORATION, Malvern, PA (US)

(21) Appl. No.: 13/812,239

(22) PCT Filed: Aug. 5, 2011
(86) PCT No.: PCT/US11/46680

§ 371 Date: Jan. 25, 2013

Related U.S. Application Data
(60) Provisional application No. 61/370,981, filed on Aug. 5, 2010.

(51) Int. Cl. C09D 1/00

(52) U.S. Cl. CPC C09D 1/00
USPC 106/286.4

(57) ABSTRACT

Embodiments of the invention relate to methods and compositions for formation of silica-based hydrogels including titanium dioxide (TiO₂) as a dispersion. Such hydrogels may be useful, for example, as a substitute or extender for titanium dioxide used in coatings.

### CROSS-REFERENCE TO RELATED APPLICATIONS

This application claims priority to U.S. Provisional Patent Application No. 61/370,981, filed on Aug. 5, 2010, and incorporated by reference herein.

### BACKGROUND OF THE INVENTION

1. Field of the Invention

Embodiments of the invention relate to methods and compositions for formation of silica-based hydrogels including titanium dioxide (TiO₂). Such hydrogels may be useful, for example, as a substitute or extender for titanium dioxide used in coatings.

2. Description of the Related Art

Various uses and formulations of titanium dioxide and substitutes for titanium dioxide are reported in the art. For example, the DuPont™ Company provides a variety of titanium dioxide coatings for various applications under the trade name Ti-PURE, as reported, for example, in the DUPONT Ti-PURE Titanium Dioxide for Coatings Booklet, which is incorporated by reference herein. (Both DUPONT and Ti-PURE are trademarks of DuPont.) Use of kaolin extenders for these and other titanium dioxide products are reported in the paper “New Generation Kaolin-Based Pigment Extenders,” by L. Ashek, published in 2003 in Surface Coatings International, as well as “Simultaneous optimization of TiO2 optical performance and binder demand in coated board formulations using knowledge from the paint chemist,” by R. Douglas Carter, Thad T. Broome and Steven C. Bacon, published in Tappi Journal, 81(11): 185-193 (1997).

Titanium dioxide is used in significant amounts in the decorative coatings sector, where it is used for the protection and decoration of buildings. In fact, titanium dioxide is so important that it is sometimes called “white gold,” because it is the raw material that contributes most to the increase in opacity and coverage of water-based paints. Titanium dioxide has a high refractive index (2.73 for rutile, 2.55 for anatase). This causes it to act as a white pigment, scattering or bending light. With enough titanium dioxide in a paint or coating, almost all visible light is reflected causing the coating to appear white, bright, and opaque.

Titanium dioxide is provided in a delivery vehicle. This may be, for example, water, vinyl resin, or acrylic resin. These compounds may have refractive indexes between 1.3 and 1.49. The greater the difference between the refractive indexes of the delivery vehicle and the refractive index of the titanium dioxide, the greater the light-scattering effect.

Size of titanium dioxide may be relevant to its efficacy. For example, typical titanium dioxide particles have a particle diameter of between 0.2 and 0.4 microns. This is about half the wavelength of light at which brightness and opacity are measured.

Dispersion of titanium dioxide is also important to performance as a brightener and opacity-creating agent. Flocculation of titanium dioxide is undesirable because it results in a larger effective particle size, decreasing the refractive effect.

Because of the expense associated with the use of titanium dioxide, effort has been expended to find substitutes or extenders. The choice of extender depends largely on the properties to be enhanced or controlled in a paint formulation. Blends of extenders may be used depending on the properties that are desired. The primary classes of titanium dioxide extenders are carbonates, silicates, sulfates, and oxides. Their particle sizes typically range from 0.01 to 44 microns. A high-gloss white paint usually contains only TiO2; a semi gloss paint contains TiO2 and some extender pigments; a flat paint contains TiO2 but has a high extender content.

The ability of a material to act as an extender to titanium dioxide is governed in part by the size of the particles in the extender. Extenders that are too large may crowd the titanium dioxide. Extenders that are too small may overly disperse the titanium dioxide. In either case the efficacy of the overall composition may be diminished.

Coatings properties are directly related to pigment volume concentration, or PVC.

These properties include, for example, gloss, permeability, porosity, hiding power, tinting strength and undertone. Because a dry paint film is a three-dimensional structure, the volume relationships among its components have an impact on paint performance. PVC is the ratio, by volume, of all pigments in the paint to total non-volatiles in the paint.

At a particular PVC, called the critical pigment volume concentration (CPVC), many physical and optical properties of paint change abruptly. Typically CPVC is the PVC where there is just sufficient binder to coat pigment surfaces and provide a continuous phase throughout the film.

% PVC={Pigment volume (TiO2+extenders)}/{Pigment volume+volume of binders}*100

Typically, PVC calculation has included only the pigment and the binder. It does not account for the air voids present in the coating. In many paint coatings, air voids are intentionally added using a structured pigment. This improves optical properties of the pigment. To account for volume of air voids, the PVC equation would be altered to include the void volume.

As air voids are incorporated into a paint film as a result of formulating highly pigmented coatings above the CPVC, the average refractive index of the vehicle matrix decreases. This increases the refractive index difference between the pigment and surrounding medium, increasing light scattering. Formulators often use dry flat hiding to improve hiding of low-gloss flat interior architectural finishes.

In addition to TiO2 and a delivery vehicle, many paints contain extender pigments. White extender pigments are mineral compounds of relatively low refractive index. They differ in composition, size and shape. White extender pigments develop very little hiding in gloss and semi-gloss paints. However, they contribute dry-flat hiding (air-pigment interface) to paints at low cost and are used to control gloss, texture, suspension, and viscosity.

Unfortunately, use of titanium dioxide imposes a high cost for raw materials; in some cases it may be ten times more expensive than other raw materials in the same formulation. Therefore, having more economical technical options is of great interest to this market. Currently, it is very common to use other raw materials to substitute titanium dioxide, even if only partially. These solutions may be of limited utility, since the coverage that they offer may not be of quality (either related to opacity or coverage or both) of titanium dioxide.

Use of titanium dioxide in combination with silica has been reported. For example, U.S. Pat. No. 6,887,822, to Hu, for “Method For Making Silica Supported Crush-Resistant Catalysts,” reports a method to make a silica support catalyst using a co-gel process with zirconium or titanium. The Hu patent reports a sol-gel process that happens on alkaline conditions (pH 8) and lower SiO₂ concentrations (8 to 14%) generating a fast gelification process that is forced through a conventional nozzle, forming hydrosol beads. The beads can be thermally treated at elevated temperatures and alkaline pH to promote rearrangement of the gel structure. The beads are reportedly washed before a catalytic metal is impregnated in an alkaline solution. The resulting product is dried to a specific moisture content of less than 5% or calcined to remove water from its composition. The presence of titanium purportedly serves to stabilize the catalyst in operation and to improve the catalytic activity.

Silica hydrogels including zirconium are reported in U.S. Pat. No. 5,069,816, to DeSantis, et al. for “Zirconium Silica Hydrogel Compositions and Method of Preparation.” The DeSantis patent reports methods for producing zirconium silica hydrogels. One reported method uses a precipitation step with metal silicate and zirconium salt in an alkaline environment followed by acidification. Another reported method includes reacting zircon with an alkali metal at elevated temperatures (1,000 to 1,200° C.) in a furnace or, in the alternative, in a pressure reactor (100 to 500 psi) at a lower temperature (100 to 150° C.). The material is presented on its dried form with small amounts of water on the compositions. Examples of the material's use on solvent paint formulations are given in comparison with one available silica gel grade.

It would be helpful to have a hydrogel that includes titanium dioxide. Such a hydrogel could act as an extender or replacement for titanium dioxide in coatings.

### BRIEF SUMMARY OF THE INVENTION

Embodiments are presented herein that provide silica hydrogel that includes titanium dioxide introduced during the acidic pH set gelification stage of production of the silica hydrogel. Before the acidic pH set gelification stage the titanium dioxide is subjected to dispersion in the sodium silicate. Embodiments also provide a silica hydrogel containing titanium dioxide.

### DETAILED DESCRIPTION OF THE INVENTION

Embodiments of the invention provide addition of titanium dioxide particles into hydrogel-type silica, where the particles are integrated into the hydrogel structure. The titanium dioxide particles increase the refractive index of the TiO₂ co-hydrogel, improving its ability to provide light scattering. The TiO₂ co-hydrogel also has the ability to provide spacing and improve the dispersion of the pure titanium dioxide particles in the paint media. The increased refractive index and the spacing/dispersion effect allow the TiO₂ co-hydrogel to act as an extender or replacement for pure titanium dioxide.

Although Applicant does not wish to be bound by theory, it is believed that the change in refractive index occurs because the titanium dioxide is chemically and physically included in the final hydrogel particle. When silica hydrogel is being produced it is possible to include titanium dioxide during the acid pH set gelification stage, where the titanium dioxide is dispersed in the sodium silicate before the acid set pH gel making reaction with sulfuric acid. Sodium Silicate is the source of silica for the formation of the hydrogel.

In addition to silica and water, the TiO₂ co-hydrogel has small amounts of titanium dioxide included within the final structure of the particle. Other impurities may be present, including for example sodium sulfate, which may be present at a level lower than 1%.

One skilled in the art will recognize that the source of titanium dioxide used in embodiments of the invention is not critical. Useful sources of titanium dioxide include, for example, rutile, anatase, brookite and the like. The source of silicate can also be sodium or potassium silicates, or any other commercial form of soluble silica. The source of acid can be, but is not limited to, sulfuric or hydrochloric acid, the major difference being the salt produced by the reaction with silicate. Sodium sulfate is produced when sulfuric and sodium silicate are used, while potassium chloride is produced when hydrochloric acid and potassium silicate are used.

A typical composition according to embodiments of the invention may include the following ingredients, with amounts given as weight
Water of constitution: 0.1% to 70%
Titanium Dioxide: 0.01% to 25%
Sulfuric or Hydrochloric acid: 0.4% to 20%
Sodium or Potassium silicate 0.5% to 35.49%
Note: Sodium silicate can be used in SiO₂:Na₂O weight ratios from 1.5 to 4.5
Note: Potassium silicate can be used in SiO₂:K₂O weight ratios from 1.5 to 3.5

The invention will best be understood with reference to an example directed to production of one or more embodiments of the invention. In the example, sodium silicate with a SiO₂:Na₂O weight ratio from 1.5 to 4.5, preferably 3.2 to 3.3, having a total solids content from 30 to 48% by weight, preferably 37 to 38%, is diluted with water to a total solids concentration of 25 to 35%, preferably 32 to 33%.

Rutile titanium dioxide (TiO₂) powder is incorporated into the diluted sodium silicate solution using a cowles disperser. Amounts of TiO₂ to be incorporated can vary from 0.4% to 20% of the total weight of the diluted silicate. Temperature of the Silicate/TiO₂ is maintained between 20 to 30° C., preferably 25° C. After dispersion the solution is kept under agitation on a separate tank that will feed the gel making process. Rutile titanium dioxide (TiO₂) slurry at typical solids content of 77% can also be blended with the dilute silicate stream on a static mixer located before the gel making eductor or at the dilute silicate storage as described above.

Sulfuric Acid having a concentration of 77 to 98% is diluted to 30-48%, preferably 36-37%. The dissolution is exothermic, so cooling is necessary to maintain temperature of the dilute acid solution between 50 to 60° C., preferably 55° C. Those skilled in the art will recognize that the gelification process may be conducted with other acids. For example, hydrochloric acid may be used.

Dilute sodium silicate with TiO₂ and dilute sulfuric acid solution are mixed in an eductor, where a quick reaction of gelification occurs. The sol-gel reaction is made at an acidic pH. Excess sulfuric acid is used in the mixture to achieve a pH of around 0 to 2, most likely 1. To control the acidity of the sol the normality is measured, with typical values ranging from 0.2 up to 1.0N, most likely 0.5 to 0.7N. It is important for the specific application that the TiO₂ dispersion into the dilute silicate be uniform and consistent to avoid potential impacts in the final quality of the end product. Uniform and consistent dispersion may be recognized, for example, by lack of deposits or of undispersed titanium particles.

The sol-gel reaction is completed in 2 to 12 minutes, typically 6 minutes. The hydrosol from the eductor has a SiO₂ concentration of 15 to 19%, typically 16% and is discharged into a gel belt that will hold the material for about 35 to 85 minutes, preferably 60 minutes. The time allows a complete reaction of the hydrogel prior to discharging to the next step.

The sol-gel reaction produces a gel type material that will be broken in the end of the gel belt and have to be washed to eliminate excess acid and to reduce the sodium sulfate (or other soluble salts depending on the source of silicate and acid) produced as a byproduct of the reaction with the sodium silicate and sulfuric acid. Gel can be washed in a continuous counter current extractor or in a water bath with the introduction of fresh water bleeding and overflow. Washing media is normally hot water at 60° C. and neutral pH.

The washing process can be done with water up to a specific conductivity or pH target, such as pH 6 for example. In another process route, the washing process can be done up to a certain intermediate pH such as 2.5 for example, followed by immediate addition of a dilute (typically 4% concentration) caustic soda to raise the pH to the same end target. There will be differences in the hydrogel structure using the water only or water/caustic process. The most notable difference is the final bulk density and degree of ageing of the hydrogel.

The gel at this stage is normally known as TiO₂ co-hydrogel. It is essentially composed of silica, water and TiO₂, with small amounts of sodium sulfate depending on how much water washing is done. Normally the amount of remaining sodium sulfate is less than 1% by weight. This TiO₂ co-hydrogel will have to be conditioned in a hot water environment to fully complete the bonding reaction of SiO₂ and release of some of the water from its structure. Expulsion of the liquid is known as condensation of the silanol groups. It is expressed by the following chemical reaction: Si-OH+HO-Si→Si-O-Si+H₂O.

The TiO₂ co-hydrogel may or may not be dried to adjust for the desired final water content of the product. It is desirable to have a final water content from 40 up to 60%, most preferably 50%.

The last step in the TiO₂ co-hydrogel preparation is a particle size reduction that can be achieved with hammer mills. Ball mills, fluid energy mills, roller mills, and the like may also be used. For optimum performance in the paint application the average particle size of the final product should be from 8 to 16 microns, most preferably 13 microns. Another key property of the final product is a low weight retained on screens 324 (<0.2% by weight) and 200 Mesh (<2% by weight). Product should be sieved to match those specifications. The presence of un milled or overly large particles in the paint will cause imperfections in the dry film.

The product of this invention will have water as one of the main constituents of its structure. Water is present at a level of 30 to 70% by weight, preferably 50%. The remaining major components of the product will be silica at a level between 25 to 70% by weight, titanium dioxide, between 0.5 and 25% by weight and sodium sulfate, between 0.1 and 2% by weight. The production of a combined silica-water product is particularly important for the application in water based paints. As a constituent of the product, water will fill the silica pores conferring low absorption to the final product. Water will also reduce the specific gravity of the final product, providing density gains when replacing TiO₂ with the product of this invention in the paint formulations.

The presence of TiO₂ in the structure of the TiO₂ co-hydrogel also result on an increased ability to replace higher amounts on titanium dioxide in water based formulations, thus providing cost benefits achieved through either replacing TiO₂ by the product of this invention and reduced densities in the new paint formula. Typical TiO₂ loading in water based paints are from 5% to 30% by weight, depending on the desired quality and type of the paint.

Although not tested as part of the product development, we also believe that a

TiO₂ co-silica could be made using a precipitation process. The precipitation process is a traditional route to make silicas for several markets such as tires and dental. The TiO₂ raw material, either in powder or slurry form, is pre-dispersed into a dilute silicate solution with concentrations around 15-30% SiO₂. The dilute silicate is added to a hot water pool to raise the pH of the reaction pool during the precipitation process. Dilute acid with concentrations around 10-30% is then added in conjunction with same dilute silicate solution with dispersed TiO₂, where the precipitation of silica will occur.

The reaction is developed at pH ranges from 8 up 10, temperature ranges from 40 up to 98° C. and a SiO2 concentration of about 5 to 10%. Brine solution or sodium chloride can also be added to the reaction pool to control particle morphology. After the reaction is completed, dilute acid is added to lower the pH to below 5.0 to stop the reaction process. Some product grades also have additional ageing time, where the temperature is maintained. This is also done to control particle morphology. The SiO2 solution is then filtered in filter presses on belt filters to separate water and washed to eliminate salts, most notably sodium sulfate when sulfuric and sodium silicate raw materials are used. The resulted washed cake will have water content from 30 up to 80%, depending on the particle morphology. This cake can be then dried in flash type dryers, such as ring or spray, to eliminate water and increase SiO₂ content in the final product. We believe that the product could be used either on its cake (with water) forms or on its dried form. The dried product will typically have a SiO₂ concentration of around 65-98%, a TiO2 concentration of 0.1 up to 35%, and water from 1 up 35%.

### EXAMPLES

An independent evaluation of the performance of this new TiO₂ co-hydrogel invention was made on an accredited laboratory in Brazil, SENAI. A water based architectural paint classified as “Premium Mat Control Formula” was selected as the control base for the study, and variations were made replacing part of the TiO₂ and part of the Acrylic Latex. Three main performance indicators of the paint were evaluated:
a. The real density of the formula, which gives an indication of potential cost saving a producer can obtain by replacing higher density pigments like TiO₂ with the material of this invention;
b. The wet coverage, which gives an indication of the hiding power of a fresh applied paint and is an indication of the paint quality;
c. The scrub resistance, which gives an indication of the strength of a cured paint film to abrasion;

The wet coverage performance is the most important property of Brazilian paints because it is the one most noticed by professional and occasional painters. The wet coverage gives an indication of the hiding power of a paint right after it is applied to the surface and is the contrast ratio (measuring the reflectance using a spectrophotometer) of a paint film over white and black board. Applied standard for the test is the ABNT NBR 14943:2003—Paints for Construction—Method for assessing the performance of paints for non-industrial buildings Determination of hiding power wet paints.

The wet abrasion test has the objective to verify if the paint film has enough strength to support the natural aggression due to manual cleaning, with no visual damage to the film appearance. The test is performed on a 7 day cured paint film using a standard scrub machine and an abrasive paste, measuring the numbers of cycles to break the film. Applied standard for the test is ABNT NBR 14943:2003—Paints for Construction—Method for assessing the performance of paints for non-industrial buildings—Determination wet abrasion with abrasive paste.

The minimum requirement established for PREMIUM MAT PAINTS in Brazil in respect to wet coverage and scrub resistance are as follows:
a. NBR14943 Wet Coverage in % (Contrast Ratio) min of 90%
b. NBR14940 Scrub Resistance min of 100 cycles

The table below express the formulas used (Control and Three Variations) and test results:

| | | | | 10% w | | 15% w | |
|---|---|---|---|---|---|---|---|
| | | | | replacement of | | replacement of | |
| Premium Mat | | 10% w | | TiO2 and 3% w | | TiO2 and 3% w | |
| White Control | | replacement | | replacement of | | replacement of | |
| Formula | % w | of TiO2 | % w | Acrylic Latex | % w | Acrylic Latex | % w |
| Ammonia 24% | 0.15 | Ammonia 24% | 0.15 | Ammonia 24% | 0.15 | Ammonia 24% | 0.15 |
| Sodium Nitrite | 0.04 | Sodium Nitrite | 0.04 | Sodium Nitrite | 0.04 | Sodium Nitrite | 0.04 |
| Bactericide | 0.15 | Bactericide | 0.15 | Bactericide | 0.15 | Bactericide | 0.15 |
| Fungicide | 0.30 | Fungicide | 0.30 | Fungicide | 0.30 | Fungicide | 0.30 |
| Tripoli | 0.04 | Tripoli | 0.04 | Tripoli | 0.04 | Tripoli | 0.04 |
| phosphate | | phosphate | | phosphate | | phosphate | |
| Dispersant | 0.25 | Dispersant | 0.25 | Dispersant | 0.25 | Dispersant | 0.25 |
| Thickener A | 0.50 | Thickener | 0.50 | Thickener | 0.50 | Thickener | 0.50 |
| Anti foam | 0.30 | Anti foam | 0.30 | Anti foam | 0.30 | Anti foam | 0.30 |
| Coalescent | 0.50 | Coalescent | 0.50 | Coalescent | 0.50 | Coalescent | 0.50 |
| Thickener B | 1.00 | Thickener B | 1.00 | Thickener B | 1.00 | Thickener B | 1.00 |
| Mineral Spirits | 0.70 | Mineral Spirits | 0.70 | Mineral Spirits | 0.70 | Mineral Spirits | 0.70 |
| Humectants | 0.25 | Humectants | 0.25 | Humectants | 0.25 | Humectants | 0.25 |
| Water | 34.00 | Water | 34.00 | Water | 34.00 | Water | 34.00 |
| PCC | 12.12 | PCC | 12.12 | PCC | 12.12 | PCC | 12.12 |
| Calcite | 9.00 | Calcite | 9.00 | Calcite | 9.00 | Calcite | 9.00 |
| Natural Kaolin | 3.00 | Natural Kaolin | 3.00 | Natural Kaolin | 3.00 | Natural Kaolin | 3.00 |
| Algamatolite | 6.70 | Algamatolite | 6.70 | Algamatolite | 6.70 | Algamatolite | 6.70 |
| TiO2 R-902 | 12.00 | TiO2 R-902 | 10.80 | TiO2 R-902 | 10.80 | TiO2 R-902 | 10.20 |
| Acrylic Latex | 19.00 | Acrylic Latex | 19.00 | Acrylic Latex | 18.50 | Acrylic Latex | 18.50 |
| Hydrogel-TiO2 | — | Hydrogel-TiO2 | 1.20 | Hydrogel-TiO2 | 1.70 | Hydrogel-TiO2 | 2.30 |
| cogel 7.8% | | cogel 7.8% | | cogel 7.8% | | cogel 7.8% | |
| Total | 100 | Total | 100 | Total | 100 | Total | 100 |
| Formula Density | 1.39 | Formula Density | 1.37 | Formula Density | 1.37 | Formula Density | 1.36 |
| | g/l | | g/l | | g/l | | g/l |
| NBR14943 Wet | 91.99% | NBR14943 | 93.73% | NBR14943 Wet | 92.82% | NBR14943 | 92.54% |
| Coverage | | Wet Coverage | | Coverage | | Wet Coverage | |
| NBR 14940 | 135 | NBR 14940 | 154 | NBR 14940 | 146 | NBR 14940 | 156 |
| Scrub Resistance | cycles | Scrub Resistance | cycles | Scrub Resistance | cycles | Scrub Resistance | cycles |

Notes:
Variation of the TiO₂ co-Hydrogel test product used contained 7.8% TiO₂ by weight on its final composition,
PCC stands for Precipitated Calcium Carbonate,
R-902 is a trade mark of

Patents, patent applications, publications, scientific articles, books, web sites, and other documents and materials referenced or mentioned herein are indicative of the levels of skill of those skilled in the art to which the inventions pertain, as of the date each publication was written, and all are incorporated by reference as if fully rewritten herein. Inclusion of a document in this specification is not an admission that the document represents prior invention or is prior art for any purpose.

We claim:

1. A method for preparing a silica hydrogel/titanium dioxide dispersion, comprising:
(a) incorporating titanium dioxide into an aqueous silicate solution, wherein said silicate solution is selected from the group consisting of a sodium silicate solution and a potassium silicate solution, forming an aqueous titanium dioxide/silicate solution;
(b) mixing the aqueous titanium dioxide/ silicate solution with acid to form a gel under acidic pH set conditions;
(c) washing the gel to reduce the amount of sodium or potassium in the gel, thereby forming a TiO₂ co-hydrogel;
(d) drying the TiO₂ co-hydrogel to achieve desired water content to maximize its performance; and
(e) milling the TiO co-hydrogel to prepare a silica hydrogel/titanium dioxide dispersion.

2. The method of claim 1, wherein said silicate solution is a sodium silicate solution having a weight ratio of SiO₂:Na₂O of from 1.5 to 4.5, and wherein said sodium silicate solution is about 25% to 45% sodium silicate by weight.

3. The method of claim 1, wherein said silicate solution is a sodium silicate solution having a weight ratio of SiO₂:Na₂O of from 3.2 to 3.3, and wherein said sodium silicate solution is about 32% to 33% sodium silicate by weight.

4. The method of claim 1, wherein said silicate solution is a potassium silicate solution having a weight ratio of SiO₂:K₂O of from 1.5 to 3.5, and wherein said potassium silicate solution is about 25% to 45% potassium silicate by weight.

5. The method of claim 1, wherein said silicate solution is a potassium silicate solution having a weight ratio of SiO₂:K₂O of from 2.1 to 2.7, and wherein said potassium silicate solution is about 28% to 40% potassium silicate by weight.

6. The method of claim 1, comprising maintaining the temperature of the aqueous titanium dioxide/silicate solution between 20 to 30 ° C.

7. The method of claim 1, wherein the titanium dioxide is incorporated in an amount between 0.4% and 20% of the total weight of the dissolved silicate.

8. The method of claim 1, wherein said titanium dioxide is incorporated as a powder.

9. The method of claim 1, wherein said titanium dioxide is incorporated as an aqueous slurry.

10. The method of claim 1, wherein said acid has a concentration of between 30-48% by weight.

11. The method of claim 10, wherein said acid has a concentration of between 36-37% by weight.

12. The method of claim 1, wherein the step of mixing the aqueous titanium dioxide/silicate solution with acid to form a gel occurs at a pH between 0 and 2.

13. The method of claim 1, comprising continuing said washing step until the hydrogel has a pH of at least 6.

14. The method of claim 1, comprising continuing said washing step until the hydrogel has a pH of at least 2.5, then ceasing said washing and adding caustic soda until the hydrogel has a pH of at least 6.

15. The method of claim 1, further comprising conditioning said hydrogel in a hot water environment at 50 to 60° C. for 2 to 8 hours.

16. A silica hydrogel/titanium dioxide dispersion comprising, by weight of the total composition:
(a) a silica hydrogel comprising water between 30-70% and silica between 25-70%;
(b) titanium dioxide between 0.5 and 25%, wherein said titanium dioxide is dispersed in the silica hydrogel; and
(d) sodium sulfate between 0.1 and 2%, wherein said sodium sulfate is dispersed in the silica hydrogel

17. The silica hydrogel/titanium dioxide dispersion of claim 16, wherein water is present at 50% and TiO₂ is present at 7.5%

18. The silica hydrogel/titanium dioxide dispersion of claim 16, where specific gravity is between 1.2 and 1.45.

19. A coating comprising, by weight, 0.5% to 30% of the silica hydrogel/titanium dioxide dispersion of claim 16.

20. The coating of claim 19, where addition of the silica hydrogel/titanium dioxide dispersion reduces the density of coating by 1 up to 10% relative to the same coating including an amount of TiO₂ powder equal to the amount of TiO₂ in the added silica hydrogel/titanium dioxide dispersion.

21. A method for preparing a silica hydrogel/titanium dioxide dispersion, comprising:
(a) dispersing TiO₂ in a silicate solution having a concentration of 15-30% SiO₂;
(b) raising the pH of the silicate solution by addition to a hot water pool;
(c) precipitating silica by combination with dilute acid having a concentration between 10-30% and thereby lowering the pH to below 5.0; and
(d) filtering and drying the precipitated silica to form a silica hydrogel/titanium dioxide dispersion.
